(19) United States
(12) Patent Application Publication
(10) Pub. No.: US 2016/0321285 A1
(43) Pub. Date: Nov. 3, 2016

(54) METHOD FOR ORGANIZING AND DISTRIBUTING DATA

(71) Applicant: Mohammad Faraz RASHID, Salem, NH (US)

(72) Inventor: Mohammad Faraz RASHID, Salem, NH (US)

(21) Appl. No.: 15/144,099

(22) Filed: May 2, 2016

Related U.S. Application Data
(60) Provisional application No. 62/156,245, filed on May 2, 2015.

(51) Int. Cl. G06F 17/30

(52) U.S. Cl. CPC G06F 17/30115; G06F 17/30082; G06F 17/30194

(57) ABSTRACT

A system for organizing and distributing data is provided. The system embodies a data structure that organizes a plurality of data types for serializing, real-time distributing, de-serializing, and storing responsive data types, while being adapted to enable analytical programmatic purposes, without the need of Internet connectivity so as to remove the device-driven bottleneck of network connectivity.

### CROSS-REFERENCE TO RELATED APPLICATION

This application claims the benefit of priority of U.S. provisional application No. 62/156,245 filed 2 May 2015, the contents of which are herein incorporated by reference.

### BACKGROUND OF THE INVENTION

The present invention relates to systems for organizing and distributing data and, more particularly, to a computer-implemented system for organizing and distributing data embodying a data structure that organizes a plurality of data types for serializing, real-time distributing, de-serializing, and storing responsive data types, while being adapted to enable analytical programmatic purposes, without the need of Internet connectivity so as to remove the device-driven bottleneck of network connectivity.

Today, data is being organized and distributed in either physical form or in digital form through a wireless Internet connection. By way of example, instructors in today's classrooms are delivering exams and classroom assignments either by printing the exam and/or assignment and distributing it to their class or alternatively distributing them across a wireless Internet connection. The first way can create a burdensome overhead on the school or institution because of ink and printing costs, while the distribution, collection and analysis of the retrieved exams and assignments can be time consuming. Internet connectivity that can be unreliable in many enterprises, and the supporting wireless network and bandwidth can be costly to maintain and handle the connected devices and constant data movement.

Presently there is not a solution for a real-time data distribution system without the need of wireless Internet connectivity. Currently, some applications allow a user to cache an offline data file locally on an electronic device, but does not allow one to distribute without Internet connectivity. In short, there are no solutions that are able to represent data artifacts in a versatile programmatic manner, enabling simple origination, duplication and distribution, as well as provide a data structure organized for analysis across a plurality of related data artifacts. Rather, solutions that exist today are limited to only static templates and applications that cannot provide a way to manipulate the object after it has been created.

As can be seen, there is a need for a system for organizing and distributing data embodying a data structure that organizes a plurality of data types for serializing, real-time distributing, de-serializing, and storing responsive data types, while being adapted to enable analytical programmatic purposes, without the need of Internet connectivity so as to remove the device-driven bottleneck of network connectivity.

### SUMMARY OF THE INVENTION

In one aspect of the present invention, a computer-implemented method for organizing and distributing data includes providing a plurality of first data types, wherein the plurality of data structures are configured to prompt a recipient device for a plurality of responsive data types; loading the plurality of first data types on a distributor device; using object-oriented programming language to create a plurality of data structures in the form of a programmatic object, wherein the plurality of data structures are configured to store the plurality of first data types and the plurality of responsive data types; and digitally sending the programmatic object to at least one recipient device across a non-Internet wireless medium.

In another aspect of the present invention, the computer-implemented method includes the programmatic object serialized prior to sending across the non-Internet wireless medium; de-serializing the programmatic object on the recipient device; incorporating the plurality of responsive data types into the programmatic object on the recipient device; and providing an automatic analytic mechanism in the programmatic object, wherein the automatic analytic mechanism is configured to comparatively analyze the plurality of responsive data types relative to the plurality of first data types, wherein the automatic analytic mechanism produces a final score based in part on the comparatively analysis of the plurality of responsive data types relative to the plurality of first data types, and wherein the programmatic object is digitally sent only across the non-Internet wireless medium.

These and other features, aspects and advantages of the present invention will become better understood with reference to the following drawings, description and claims.

### BRIEF DESCRIPTION OF THE DRAWINGS

FIG. 1 is a schematic view of an exemplary embodiment of the present invention;

FIG. 2 is a flow chart of an exemplary embodiment of the present invention; and

FIG. 3 is a schematic view of an exemplary embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a system for organizing and distributing data embodying a data structure that organizes a plurality of data types for serializing, real-time distributing, de-serializing, and storing responsive data types, while being adapted to enable analytical programmatic purposes, without the need of Internet connectivity so as to remove the device-driven bottleneck of network connectivity.

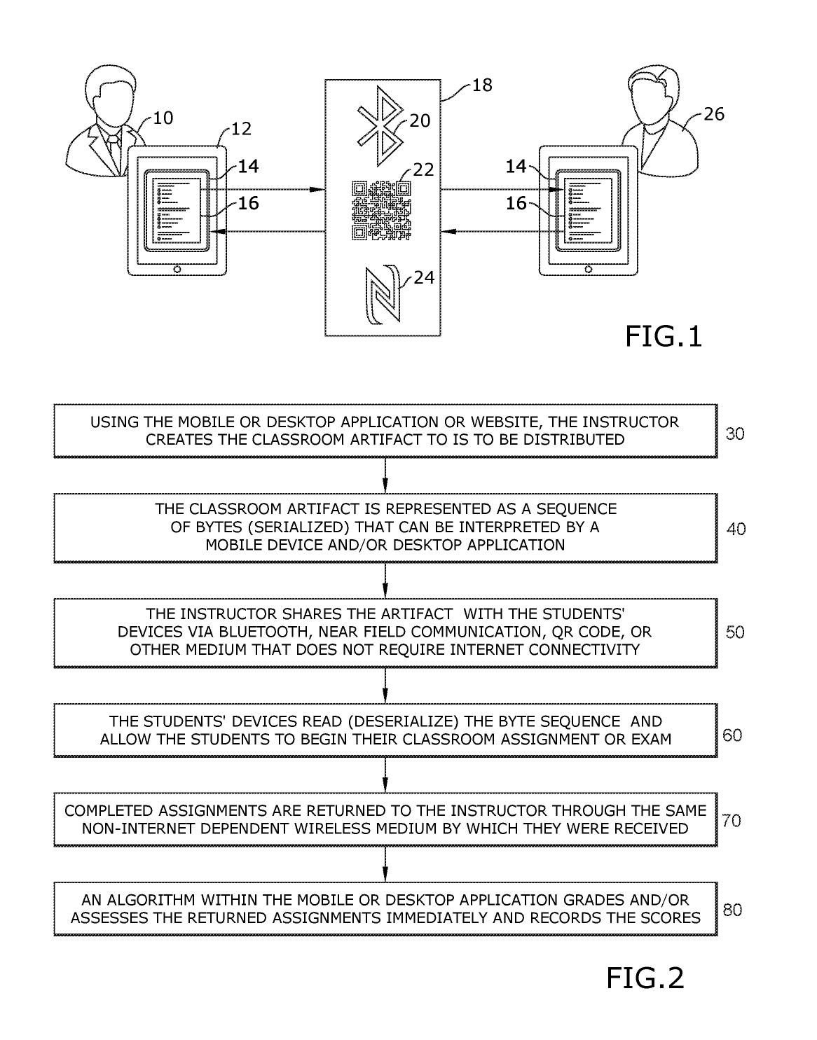

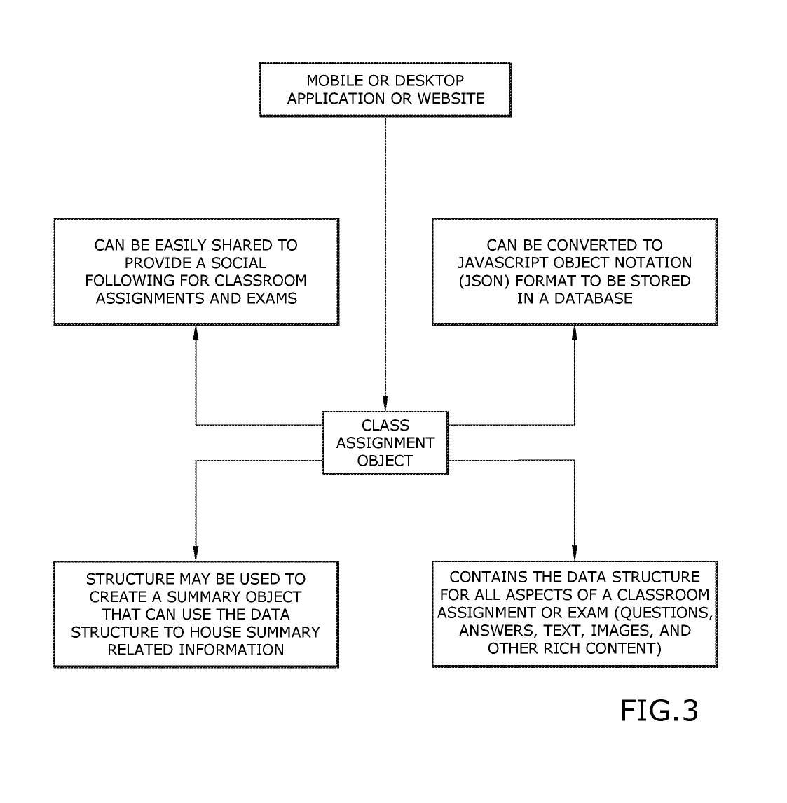

Referring to FIGS. 1 and 3, the present invention may include at least one computer 12 with a user interface. Each computer 12 may include at least one processing unit and a form of memory including, but not limited to, a desktop, laptop, and smart device, such as, a tablet and smart phone. Each computer 12 may include a program product including a machine-readable program code for causing, when executed, each computer 12 to perform steps. The program product may include software which may either be loaded onto each computer 12 or accessed by the computer 12 having on-board capabilities. The loaded software may include an application 14 on each computer/smart device 12, as illustrated in FIG. 1. The software may be accessed by each computer 12 via a non-Internet dependent wireless medium or sharing tool 18, such as Bluetooth communication 20, QR Code 22, near field communication (NFC) 24, and the like.

A distributor 10, may selectively engage the software through the application 14 on the computer/smart device 12, wherein the application 14 is adapted to receive a plurality of inputted first data types and process the inputted first data types so as to create a plurality of custom programmatic objects 16. The plurality of programmatic objects 16 may be developed using an object-oriented programming language. Each programmatic object 16 may be designed to include individual data structures (i.e. arrays, lists, maps etc.) adapted to store the plurality of inputted first data types and subsequently inputted associated responsive data types, including metadata. Each programmatic object 16 may contain the data structure needed to easily set and retrieve the inputted first data types and subsequently inputted associated responsive data types for programmatic purposes.

Each programmatic object 16 may be adapted to be serialized so that it can be sent across the non-Internet dependent wireless medium 18 to a recipient 26. Each programmatic object 16 cannot only serve as a container for the plurality of first data types but it can also be used to house the associated responsive data types of the recipient 26.

Multiple programmatic object 16 can be sampled to provide analytics across a set of the data types. In certain embodiments, the programmatic object 16 may be converted to JSON format that could be fed into a database, or any relevant persistence data store, and have a RESTful Application Programming Interface or API access it. Examples of databases that provide a RESTful service include Cloudant and MongoDB. This would allow for deep analytics across a distribution of programmatic objects 16 that can in turn be represented as graphical models to an interested user, like the distributor 10. The data gathered and can also be of monetary value to an educational institution.

The programmatic object 16 may provide an automatic analytic mechanism adapted to selectively analyze the plurality of first data types and the associated responsive data types. As previously mentioned, the data structure of each programmatic object 16 acts as a container for the plurality of first data types—for example a classroom assignment and exam information in an instructor-student dynamic—as well as a container to house the associated responsive data types incorporated in the programmatic object 16 by the recipients 26—for example, a student's answers to the assignment and exam information. This data structure may be similar to that of a key-value pair map. Once the responsive data types (e.g., the student's answers) can be retrieved and be compared to that of the first data types (e.g., an instructor's answers) a final score may be produced on the fly for the recipient 26-student and/or distributor 10-instructor.

The mobile application 14 (on the device) enables the distributor 10 to create the programmatic object 16 so as to contain a plurality of data types. The mobile application 14 then takes the programmatic object 16 and converts into a sequence of bytes that are submitted from one device to another device in and around their locality via the wireless medium 18. The receiving device receives the sequence of bytes via the wireless medium 18. Then the mobile application 14 interprets the sequence of bytes and creates the programmatic object 16 for the recipient 26 to open and input associated responsive data then incorporated in the programmatic object 16. Once the recipient 26 has saved the responded-to programmatic object 16, it may be immediately analyzed and stored for the distributor 10 or the recipient 26 to gauge their progress.

In a school setting, referring to FIG. 2, the present invention may be used as followings. In step 30, an instructor 10 creates a classroom artifact (custom programmatic object 16), for example an exam or assignment, for distribution to at least one student 26. The classroom artifact is serialized so as to represented the plurality of first data types, for example text and graphical portions along with questions and prompts, incorporated in the classroom artifact 16 as a sequence of bytes, in step 40. Such serialized classroom artifact 16 may be interpreted by a mobile device 12 and/or desktop application 14. In step 50, the instructor 10 may share the classroom artifact 16 with at least one student 26 via Bluetooth 20, NFC 24, QR code 20, or other non-Internet wireless media 18. In step 60, at least one student 26 de-serializes the byte sequence so as to selectively engage and respond to the classroom artifact 16. Completed assignments 16 are returned to the instructor 10 through the same non-Internet dependent wireless medium 18, in step 70. An algorithm within the mobile device 12 grades and/or assesses the returned assignment 16 immediately and records the score, in step 80.

It should be understood that although an exemplary instructor-student(s) dynamic within a classroom setting has been referenced for illustrative purposes, the present invention could be a boon in almost any local setting or enterprise. For example, in the medical field, medical professionals could securely share data via devices without any worrying of data breaches or interception of any kind, and also enabling the creation of medical information, reports and the like. Furthermore, the present invention teaches making custom devices geared for sharing information in a local setting so that, for example, in a medical facility special devices could share data with other medical professionals and/or devices.

The computer-based data processing system and method described above is for purposes of example only, and may be implemented in any type of computer system or programming or processing environment, or in a computer program, alone or in conjunction with hardware. The present invention may also be implemented in software stored on a computer-readable medium and executed as a computer program on a general purpose or special purpose computer. For clarity, only those aspects of the system germane to the invention are described, and product details well known in the art are omitted. For the same reason, the computer hardware is not described in further detail. It should thus be understood that the invention is not limited to any specific computer language, program, or computer. It is further contemplated that the present invention may be run on a stand-alone computer system, or may be run from a server computer system that can be accessed by a plurality of client computer systems interconnected over an intranet network, or that is accessible to clients over the Internet. In addition, many embodiments of the present invention have application to a wide range of industries. To the extent the present application discloses a system, the method implemented by that system, as well as software stored on a computer-readable medium and executed as a computer program to perform the method on a general purpose or special purpose computer, are within the scope of the present invention. Further, to the extent the present application discloses a method, a system of apparatuses configured to implement the method are within the scope of the present invention.

It should be understood, of course, that the foregoing relates to exemplary embodiments of the invention and that modifications may be made without departing from the spirit and scope of the invention as set forth in the following claims.

What is claimed is:

1. A computer-implemented method for organizing and distributing data, comprising:
providing a plurality of first data types, wherein the plurality of data structures are configured to prompt a recipient device for a plurality of responsive data types;
loading the plurality of first data types on a distributor device;
using object-oriented programming language to create a plurality of data structures in the form of a programmatic object, wherein the plurality of data structures are configured to store the plurality of first data types and the plurality of responsive data types; and
digitally sending the programmatic object to at least one recipient device across a non-Internet wireless medium.

2. The method of claim 1, wherein the programmatic object is serialized prior to sending across the non-Internet wireless medium.

3. The method of claim 2, further comprising de-serializing the programmatic object on the recipient device.

4. The method of claim 3, further comprising incorporating the plurality of responsive data types into the programmatic object on the recipient device.

5. The method of claim 4, further comprising providing an automatic analytic mechanism in the programmatic object, wherein the automatic analytic mechanism is configured to comparatively analyze the plurality of responsive data types relative to the plurality of first data types.

6. The method of claim 5, wherein the automatic analytic mechanism produces a final score based in part on the comparatively analysis of the plurality of responsive data types relative to the plurality of first data types.

7. The method of claim 6, wherein the programmatic object is digitally sent only across the non-Internet wireless medium.
